(19) United States
(12) Patent Application Publication
(10) Pub. No.: US 2006/0141149 A1
(43) Pub. Date: Jun. 29, 2006

(54) Method for forming superparamagnetic nanoparticles

(75) Inventors: Ming-Yao Chen, Taipei (TW); Wen-Hsiang Chang, Taipei (TW); Chin-I Lin, Tainan (TW); Shian-Jy Jassy Wang, Hsinchu (TW); Yuh-Jiuan Lin, Taipei (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/101,561

(22) Filed: Apr. 8, 2005

(30) Foreign Application Priority Data
Dec. 29, 2004 (TW) 93141160

(51) Int. Cl. C01G 49/02; B05D 7/00

(52) U.S. Cl. 427/212; 423/632

(57) ABSTRACT

A method for forming a superparamagnetic nanoparticle. The method includes providing an aqueous solution comprising Fe²⁺ and Fe³⁺ ions and adding alkali to the aqueous solution. An iron oxide nanoparticle is formed by subjecting the aqueous solution to ultrasonic vibration and collected.

### BACKGROUND

The invention relates to a nanoparticle and in particular to a method for forming superparamagnetic nanoparticles.

Research shows hemoglobin, water and phospholipids exhibiting the lowest absorption in 650˜900 nm, NIR region. Therefore, the NIR can be used as an excited source through a media, such as silica-gold core-shell particle, to identify tissue.

Superparamagnetic iron oxide nanoparticles have a diameter of about 5˜40 nm. This nanoparticle only exhibits magnetism under a magnetic field, and thus can be used in magnetic-related applications.

Iron oxide-gold core-shell nanoparticles have the NIR absorption characteristics of gold shell and the superparamagnetic characteristics of iron oxide core. However, the iron oxide particle is usually formed in organic solution or micelle, and thus is too large for application in biomedicine. The gold layer easily peels and is hard to modify.

### SUMMARY

Accordingly, embodiments of the invention provide a method for forming a superparamagnetic nanoparticle.

In one embodiment, an aqueous solution comprising Fe²⁺ and Fe³⁺ ions is provided and an alkali added into the aqueous solution. An iron oxide nanoparticle is formed by subjecting the aqueous solution to ultrasonic vibration and collected.

In another embodiment, an iron oxide nanoparticle as mentioned is dispersed in an aqueous solution. A metal seed layer is formed on the iron oxide nanoparticle. An electrolyte comprising gold ions and a reducing agent are added to the aqueous solution to form an iron oxide-gold core-shell nanoparticle. The iron oxide-gold core-shell nanoparticle is collected.

### DESCRIPTION OF THE DRAWINGS

The embodiments can be more fully understood by reading the subsequent detailed description and Examples with references made to the accompanying drawings, wherein:

FIGS. 1A˜1D are schematics of iron oxide-gold core-shell nanoparticle formation and modification process of an embodiment.

FIGS. 2A˜2B shows schematics of a modified iron oxide-gold core-shell nanoparticle.

FIG. 3 is an iron oxide nanoparticle. XRD diagram of Example 1.

FIG. 4 is an iron oxide nanoparticle SEM picture of Example 1.

FIG. 5 is an iron oxide nanoparticle TEM picture of Example 1.

FIG. 6 is an iron oxide nanoparticle SAXA diagram of Example 1.

FIG. 7 is an iron oxide nanoparticle VSM diagram of Example 1.

FIGS. 8˜16 show respectively iron oxide-gold layer core-shell nanoparticle absorption spectrums of Example 2˜10.

FIG. 17 is an iron oxide-gold layer core-shell nanoparticle TEM picture of Example 3.

FIG. 18 is an iron oxide-gold layer core-shell nanoparticle TEM picture of Example 4.

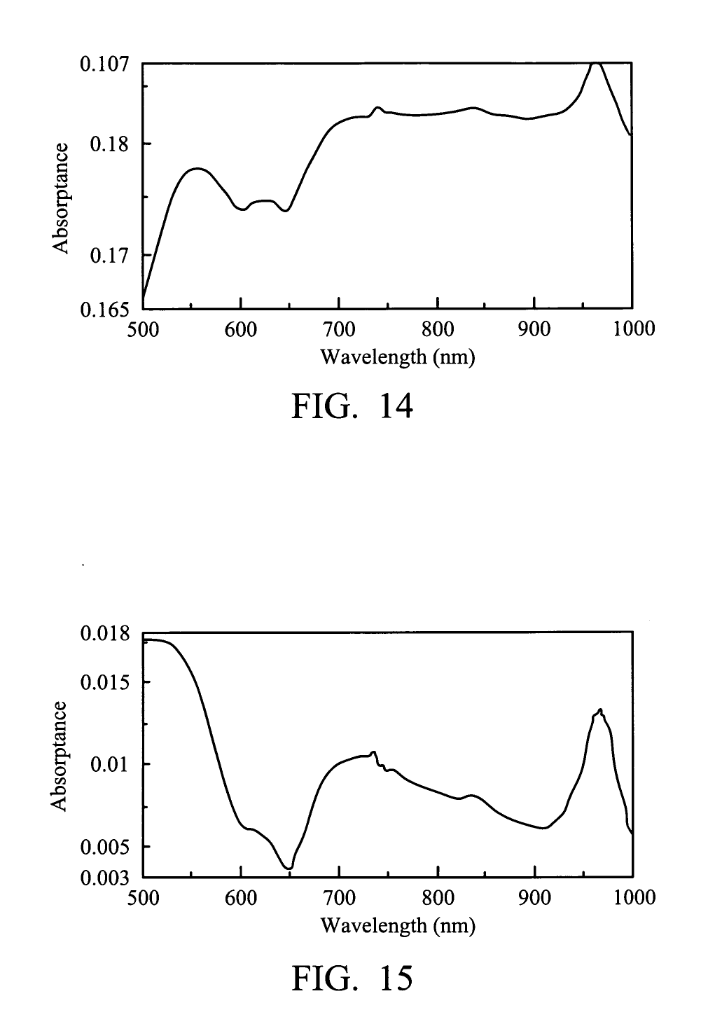

FIG. 19 is an iron oxide-gold layer core-shell nanoparticle TEM picture of Example 8.

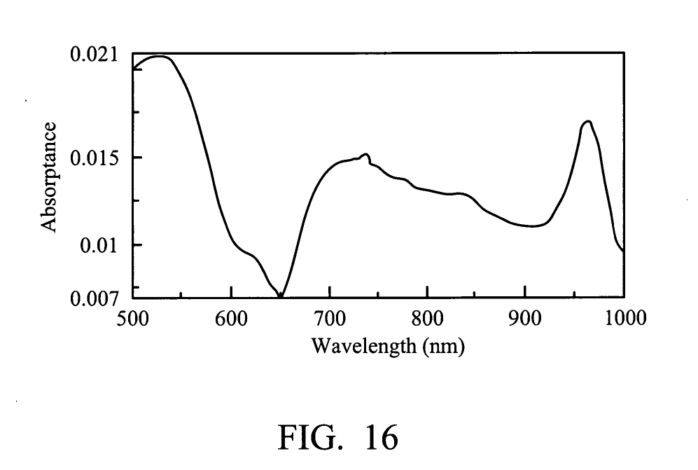

FIG. 20 is an iron oxide-gold layer core-shell nanoparticle TEM picture of Example 10.

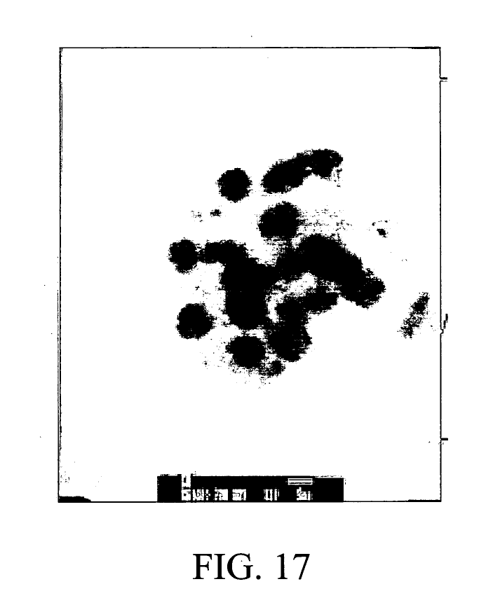

FIG. 21 shows modified iron oxide-gold layer core-shell nanoparticle IR spectrums of Example 11.

FIG. 22 shows modified iron oxide-gold layer core-shell nanoparticle IR spectrums of Example 12.

FIG. 23 shows modified iron oxide-gold layer core-shell nanoparticle IR spectrums of Example 13.

FIG. 24 shows modified iron oxide-gold layer core-shell nanoparticle IR spectrums of Example 14.

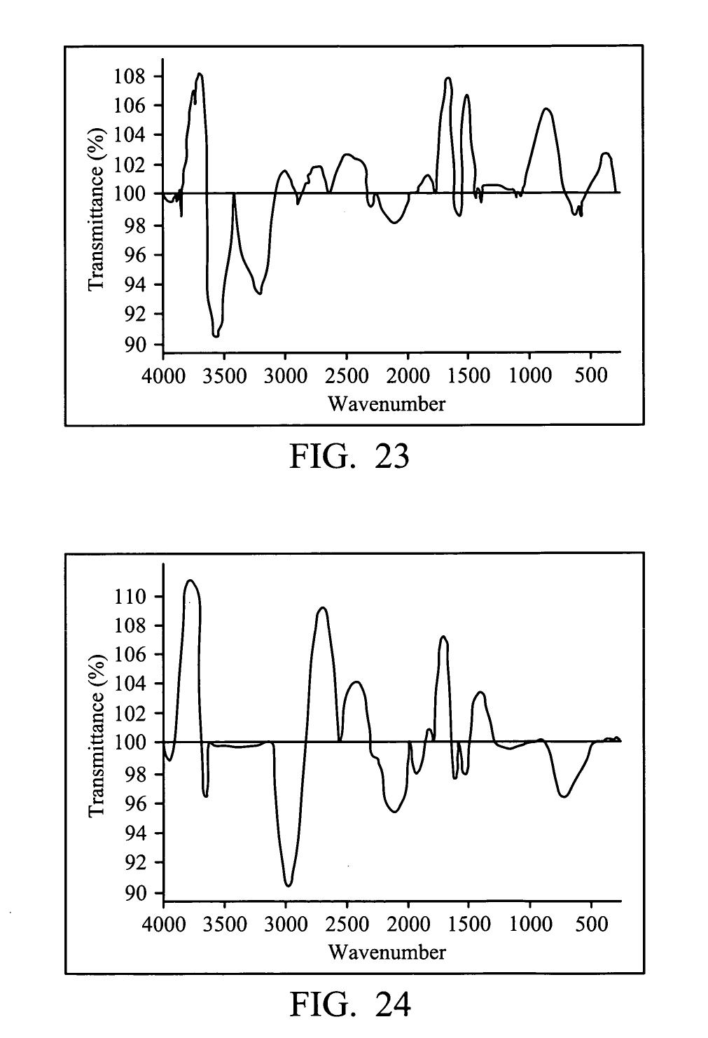

### DETAILED DESCRIPTION

Superparamagnetic Nanoparticle Forming Method

Superparamagnetic nanoparticle of the embodiment is formed by chemical co-precipitation:

An aqueous solution comprising Fe²⁺ and Fe³⁺ ions in a ration of about 1:2˜1:3 is provided. Acid can be add to the aqueous solution to increase the Fe²⁺ and Fe³⁺ ion concentration, such as HCl.

The aqueous solution pH is adjusted to 12 or higher with alkali to improve iron oxide nanoparticle formation. The alkali may comprise an organic base or an inorganic base. The inorganic base is preferably an alkali metal hydroxide, such as NaOH.

Iron oxide nanoparticles are formed by subjecting the aqueous solution to ultrasonic vibration at about 40˜70° C. Iron oxide nanoparticles are collected by a magnet. The iron oxide nanoparticles comprise Fe₃O₄ and/or Fe₂O₃ as a diameter of about 5˜40 nm. Such diameter iron oxide has superparamagnetic characteristics.

Core-Shell Nanoparticle Forming Method

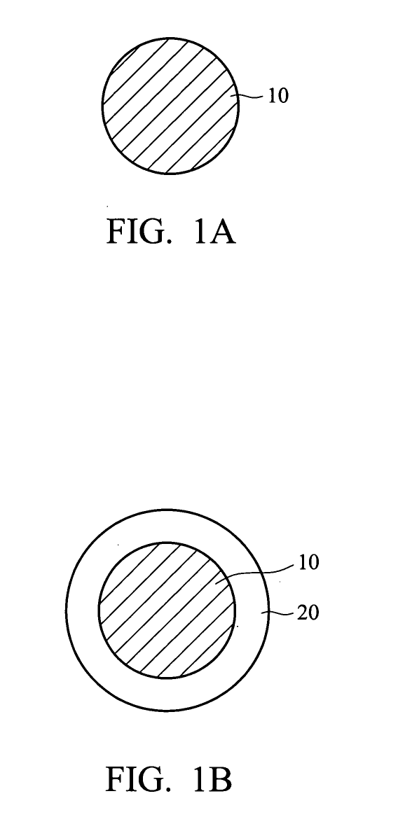

FIGS. 1A˜1D show a forming method of core-shell nanoparticle of the embodiment.

In FIG. 1A, an iron oxide nanoparticle 10 as synthesized herein is dispersed into an aqueous solution. An ultrasonic vibration treatment applied to the aqueous solution improves the iron oxide nanoparticle 10 in aqueous solution dispersion.

A metal seed layer 20 is formed on the iron oxide nanoparticle 10, as shown in FIG. 1B. The metal seed layer 20 comprises Sn, used as a linker or nucleation site to improve gold reduction during subsequent gold formation.

An electrolyte comprising gold ions and a reducing agent are added to the aqueous solution to form an iron oxide-gold core-shell nanoparticle 40, as shown in FIG. 1C. The electrolyte may comprise AuCl₃ and the reducing agent may comprise formaldehyde. The iron oxide-gold core-shell nanoparticle 40 is collected by a magnet.

NIR absorption wavelength of the iron oxide-gold core-shell nanoparticle 40 can be tuned by different gold layer 30 thicknesses, related to the iron oxide nanoparticle 10 size and a weight ratio of the iron oxide core 10 to the gold shell 30. For example, the gold shell 30 can be about 5˜40 nm thick, and the iron oxide-gold core-shell nanoparticle 40 a diameter of about 10˜50 nm, at weight ratio about 1:0.03˜1:10.

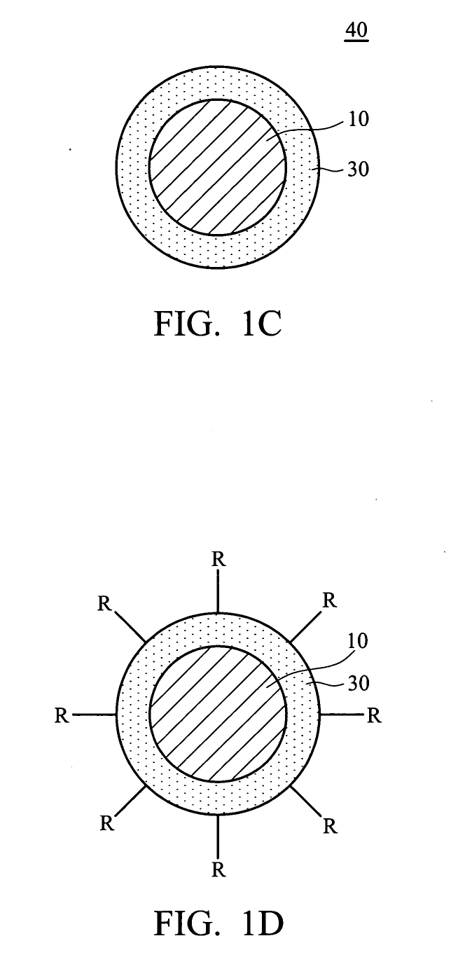

Furthermore, iron oxide-gold core-shell nanoparticle 40 can be modified with a modifying agent, as shown in FIG. 1D. When the modifying agent is 3-mercaptopropionic acid, the iron oxide-gold core-shell nanoparticle 40 is modified as FIG. 2A. When the modifying agent is 2-aminoethanethiol, the iron oxide-gold core-shell nanoparticle 40 is modified as FIG. 2B.

### EXAMPLE 1

### Nanoparticle

An iron oxide nanoparticle was formed by the above-mentioned method, wherein the Fe²⁺ and Fe³⁺ ions ratio was 1:2 and the added alkali NaOH.

The iron oxide nanoparticle was identified by X-ray diffraction (XRD), scanning electron microscopy (SEM), transmission electron microscopy (TEM), small-angle X-ray scattering (SAXS) and vibration sampling magnetometer (VSM). The result is disclosed as follows:

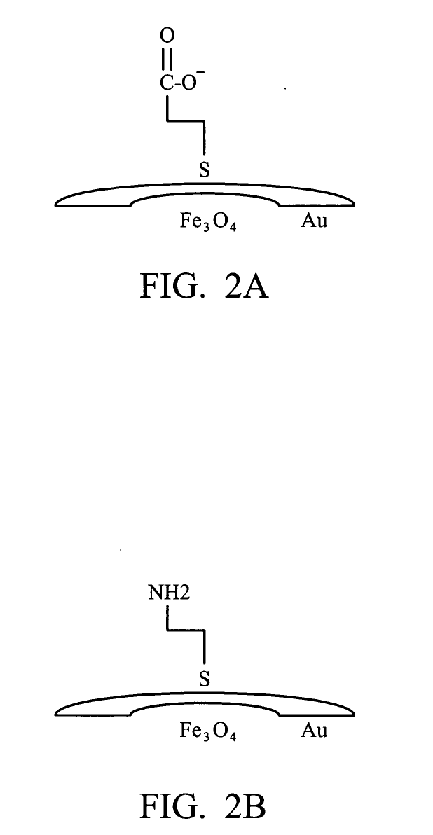

FIG. 3 is a XRD diagram of the iron oxide nanoparticle. It shows that the iron oxide nanoparticle comprises Fe₃O₄ diffraction peak.

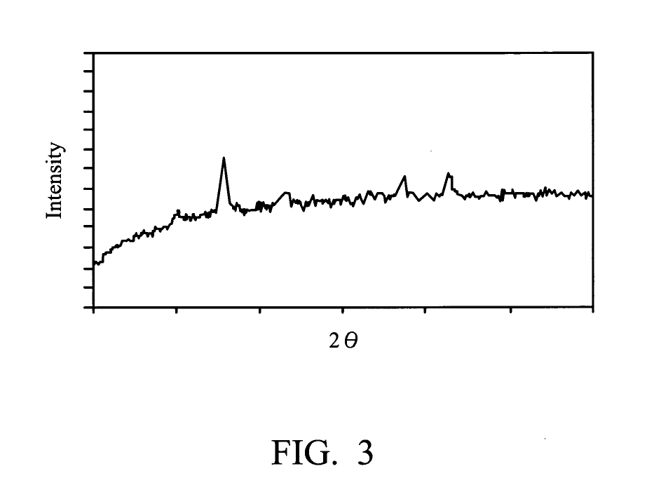

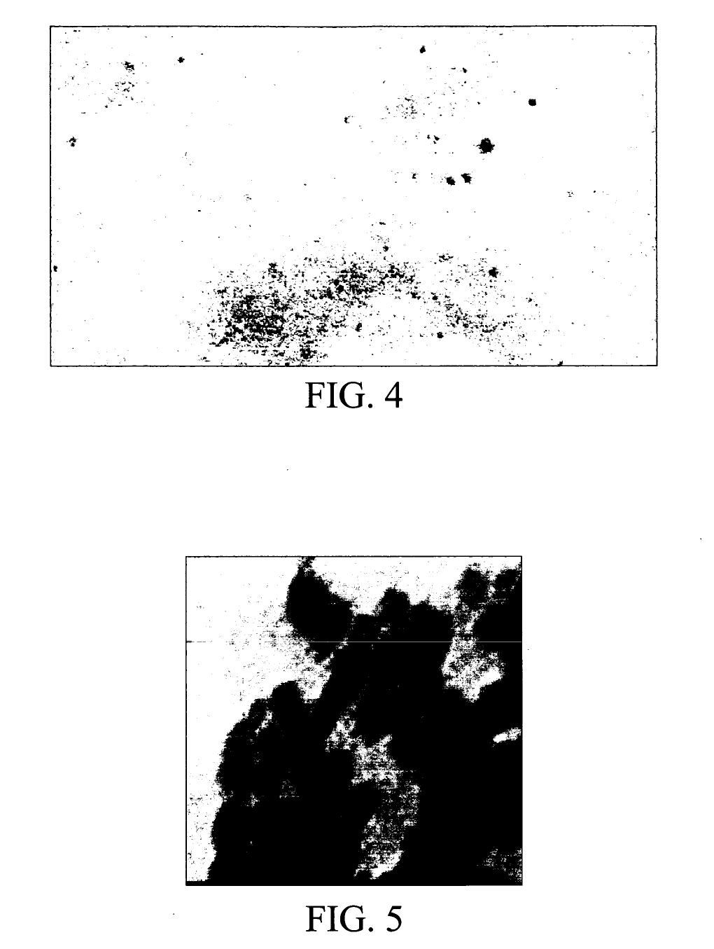

FIGS. 4 and 5 are respectively SEM and TEM pictures of the iron oxide nanoparticle. They show the iron oxide nanoparticle having a diameter is about 5˜40 nm.

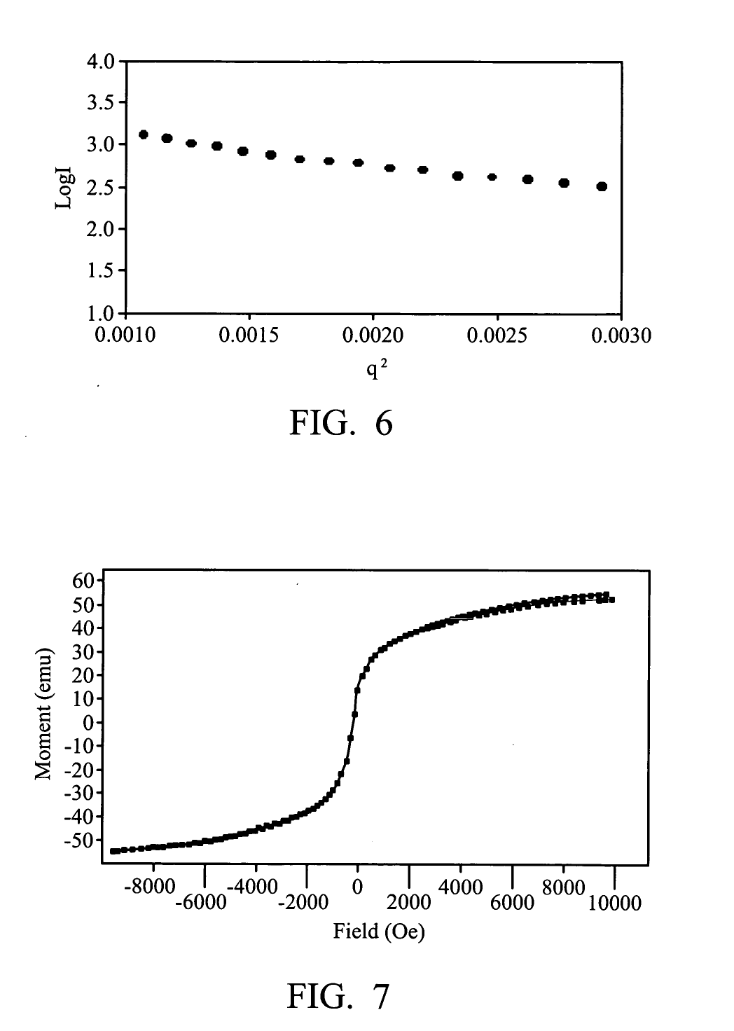

FIG. 6 is a SAXS diagram of the iron oxide nanoparticle. It shows that the iron oxide nanoparticle has a diameter of about 8.4 nm.

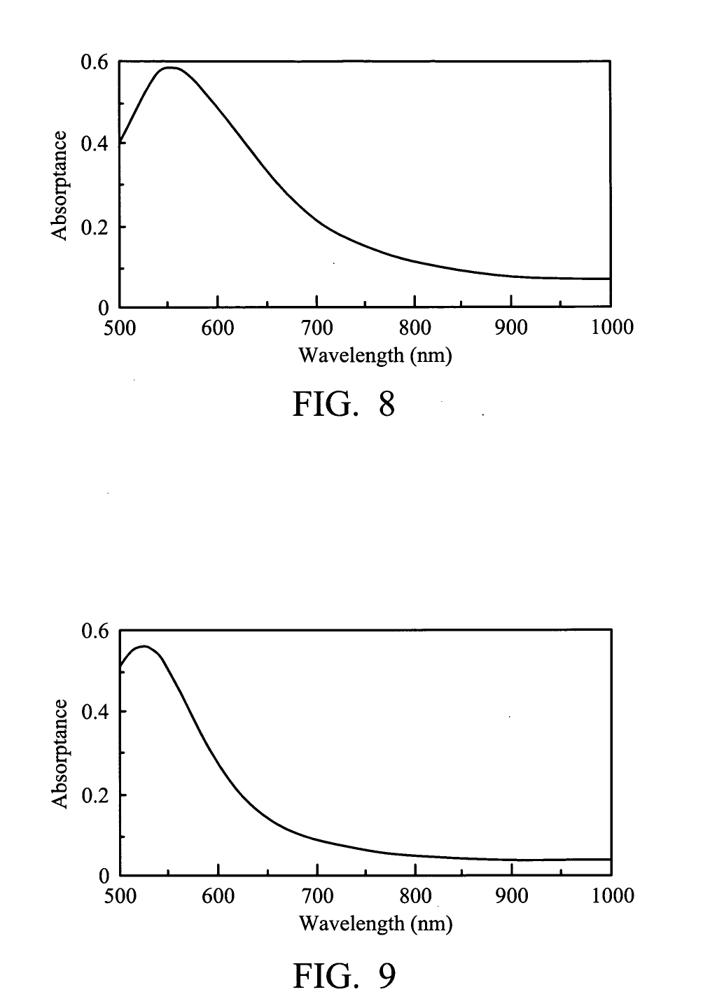

FIG. 7 is a VSM diagram of the iron oxide nanoparticle. It shows that the iron oxide nanoparticle has a magnetization of about 54.6 emu/g, and thus the iron oxide nanoparticle is superparamagnetic.

### EXAMPLE 2˜10

### Core-Shell Nanoparticle

Iron oxide nanoparticles of Example 2˜10 were formed as follows:

An iron oxide nanoparticle was dispersed to an aqueous solution and an ultrasonic vibration treatment applied to the aqueous solution to improve the iron oxide nanoparticle dispersion. 2.5*10⁻³ M SnCl₂ was added into the aqueous solution to form a Sn metal seed layer on the iron oxide nanoparticle surface. 25 mM AuCl₃ and 15 mM K₂CO₃ were reacted overnight and added to the aqueous solution, with the Au to iron oxide weight ratio shown in Table 1. Formaldehyde was added to the aqueous solution to form an iron oxide-gold core-shell nanoparticle. The iron oxide-gold core-shell nanoparticle was collected by a magnet. The absorption spectrums and TEM pictures of Example 2˜10 are listed in Table 1.

TABLE 1

| | | Absorption | |
|---|---|---|---|
| | iron oxide:Au | Spectrum | TEM |
| Example 2 | 1:0.03 | | |
| Example 3 | 1:0.04 | | |
| Example 4 | 1:0.05 | | |
| Example 5 | 1:0.06 | | |
| Example 6 | 1:0.1 | | |
| Example 7 | 1:0.2 | | |
| Example 8 | 1:1 | | |
| Example 9 | 1:5 | | |
| Example 10 | 1:10 | | |

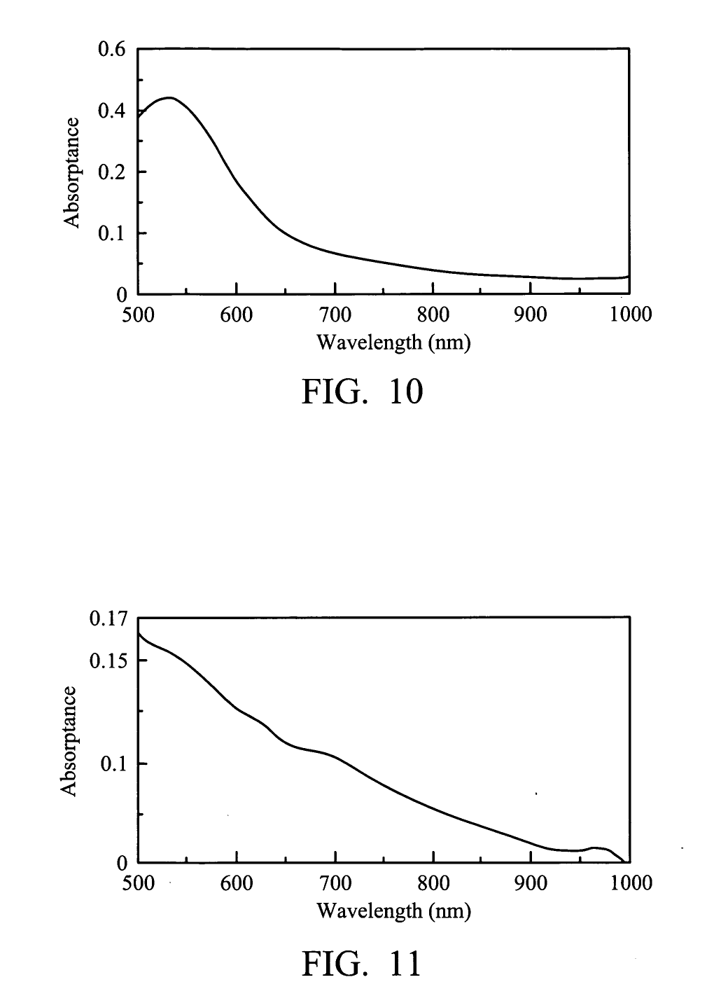

FIGS. 8˜16 are absorption spectrums of the iron oxide nanoparticle. They show the iron oxide nanoparticles NIR absorption peaks excited by VU.

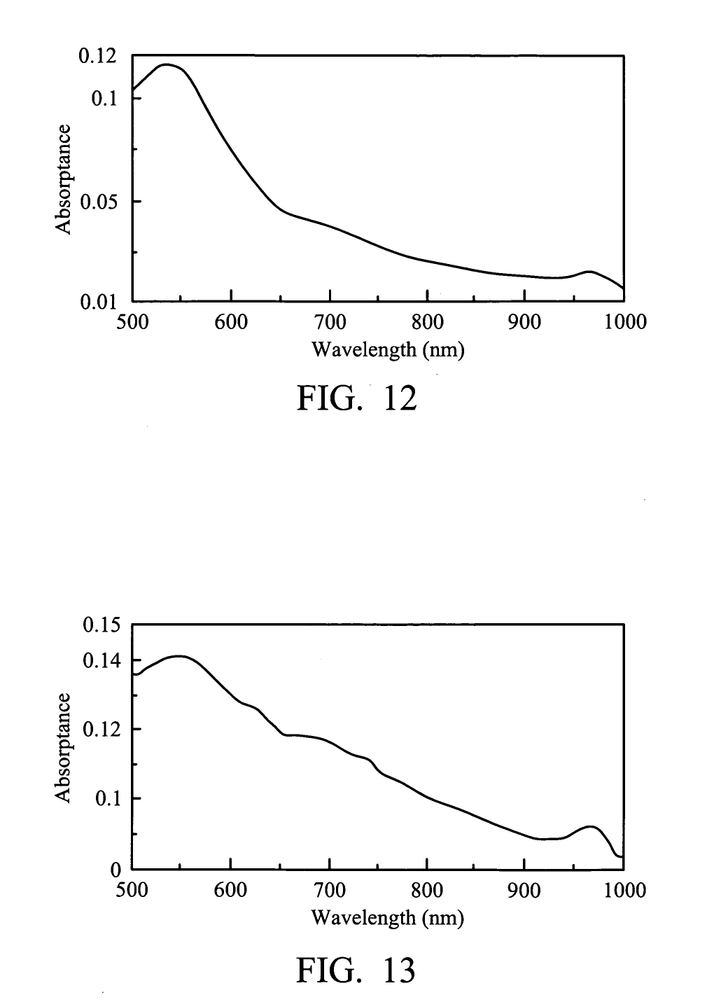

FIGS. 17˜20 are TEM pictures of the iron oxide nanoparticle. They show the iron oxide nanoparticle has a diameter of about 10˜50 nm.

### EXAMPLE 11

### Modified Core-Shell Nanoparticles

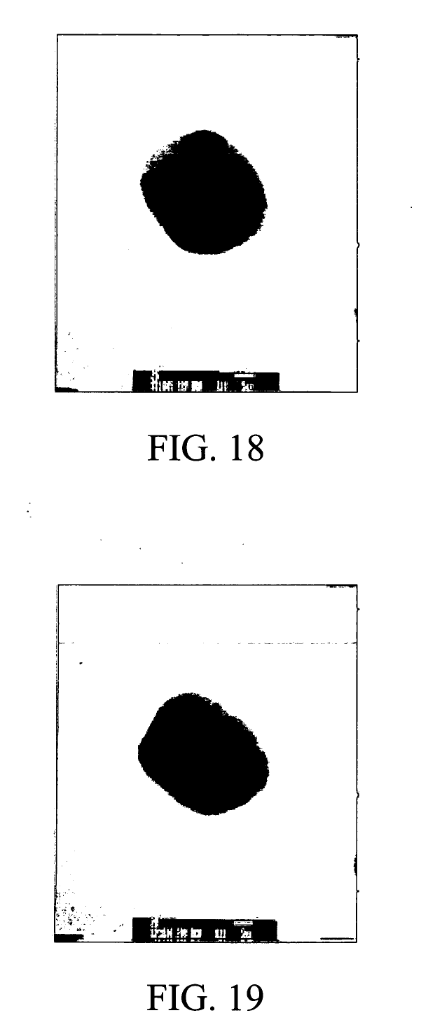

Iron oxide-gold core-shell nanoparticles of Example 3 were modified with 10 mM 3-mercaptopropionic acid to form a COOH group on the iron oxide-gold core-shell nanoparticle surface. Its IR spectrum is shown in FIG. 21.

### EXAMPLE 2˜10

### Modified Core-Shell Nanoparticle

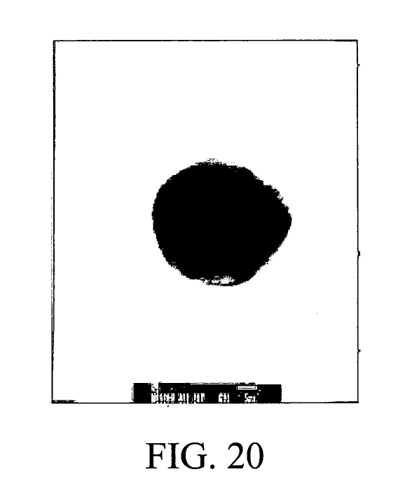

Iron oxide-gold core-shell nanoparticles of Example 10 were modified with 10 mM 3-mercaptopropionic acid to form a COOH group on the iron oxide-gold core-shell nanoparticle surface. Its IR spectrum is shown in FIG. 22.

### EXAMPLE 2˜10

### Modified Core-Shell Nanoparticle

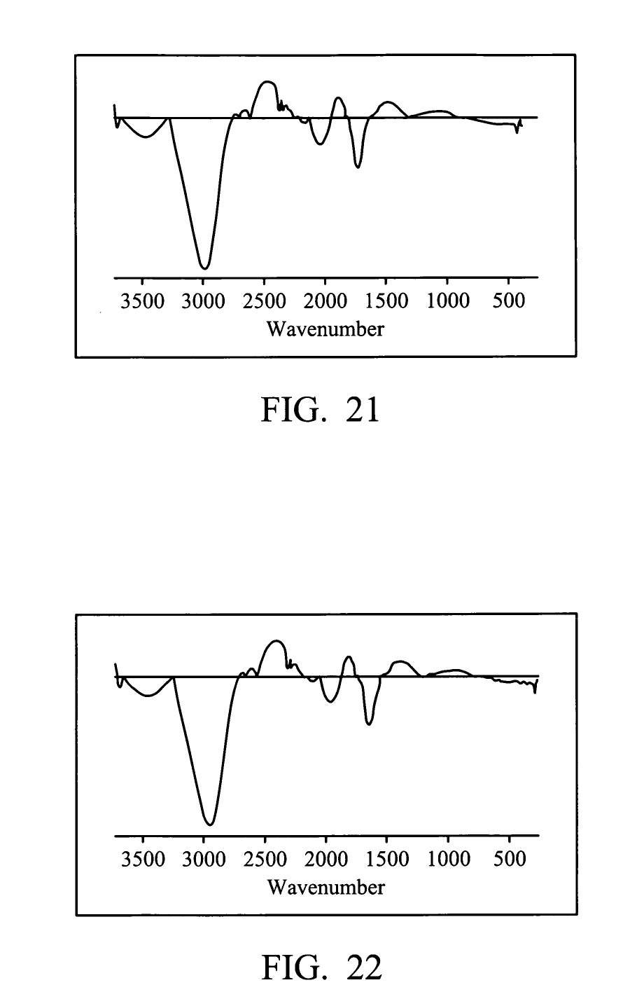

Iron oxide-gold core-shell nanoparticles of Example 3 were modified with 10 mM 2-aminoethanethiol to form a NH₂ group on the iron oxide-gold core-shell nanoparticle surface. Its IR spectrum is shown in FIG. 23.

### EXAMPLE 2˜10

### Modified Core-Shell Nanoparticle

Iron oxide-gold core-shell nanoparticles of Example 10 were modified with 10 mM 2-aminoethanethiol to form a NH₂ group on the iron oxide-gold core-shell nanoparticle surface. Its IR spectrum is shown in FIG. 23.

The nanoparticle, core-shell nanoparticle and modified core-shell nanoparticle comprise the following features:

1. Superparamagnetic iron oxide nanoparticle of the present invention is synthesized in aqueous solution, thus it is suitable for biomedical applications.

2. Iron oxide core and gold shell of the present invention was boned with a chemical bond, and thus the gold shell does not easily peel.

3. Iron oxide-gold core-shell nanoparticle is easily modified, and thus it is suitable for a wide variety of targeting therapies.

4. The nanoparticle, core-shell nanoparticle and modified core-shell nanoparticle can be used in many fields based on their magnetic, optical and thermal characteristics, such as NMR developer, specific tissue identification developer, purification and magnetic thermal therapy (hyperthermia).

While the invention has been described by way of Example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A method for forming a superparamagnetic nanoparticle, comprising:
providing an aqueous solution comprising Fe²⁺ and Fe³⁺ ions;
adding alkali to the aqueous solution;
forming an iron oxide nanoparticle by subjecting the aqueous solution to ultrasonic vibration; and
collecting the iron oxide nanoparticle thus formed.

2. The method as claimed in claim 1, wherein the Fe²⁺ and Fe³⁺ ions in the aqueous solution have a ratio of about 1:2˜1:3.

3. The method as claimed in claim 1, before adding alkali to the aqueous solution, further comprising, adding acid to the aqueous solution.

4. The method as claimed in claim 3, wherein the acid is HCl.

5. The method as claimed in claim 1, after adding alkali to the aqueous solution, wherein, the aqueous solution has a pH above 12.

6. The method as claimed in claim 1, wherein the alkali comprises an organic base or an inorganic base.

7. The method as claimed in claim 6, wherein the inorganic base comprises an alkali metal hydroxide.

8. The method as claimed in claim 7, wherein the alkali metal hydroxide comprises NaOH.

9. The method as claimed in claim 1, wherein the ultrasonic vibration is performed at 40˜70° C.

10. The method as claimed in claim 1, wherein the iron oxide nanoparticle comprises Fe₃O₄ and/or Fe₂O₃ nanoparticle.

11. The method as claimed in claim 1, wherein the iron oxide nanoparticle has a diameter of about 5˜40 nm.

12. The method as claimed in claim 1, wherein collection of the iron oxide nanoparticle comprises absorption of the iron oxide nanoparticle by a magnet.

13. A method for forming a superparamagnetic nanoparticle, comprising:
dispersing an iron oxide nanoparticle as claimed in claim 1 into an aqueous solution;
forming a metal seed layer on the iron oxide nanoparticle;
adding an electrolyte comprising gold ions and a reducing agent to the aqueous solution to form an iron oxide-gold core-shell nanoparticle; and
collecting the iron oxide-gold core-shell nanoparticle.

14. The method as claimed in claim 13, wherein dispersal of the iron oxide nanoparticle into an aqueous solution further comprises an ultrasonic vibration treatment.

15. The method as claimed in claim 13, wherein the metal seed layer comprises Sn.

16. The method as claimed in claim 13, wherein the electrolyte comprises AuCl₃.

17. The method as claimed in claim 13, wherein the reducing agent comprises formaldehyde.

18. The method as claimed in claim 13, wherein a weight ratio of the iron oxide core to the gold shell is about 1:0.03˜1:10.

19. The method as claimed in claim 13, wherein the gold shell is about 5˜40 nm thick.

20. The method as claimed in claim 13, wherein the iron oxide-gold core-shell nanoparticle has a diameter of about 10˜50 nm.

21. The method as claimed in claim 13, wherein collection of the iron oxide-gold core-shell nanoparticle comprises absorption of the iron oxide core/Au shell nanoparticle by a magnet.

22. The method as claimed in claim 13, further comprising modifying the iron oxide-gold core-shell nanoparticle with a modifying agent.

23. The method as claimed in claim 22, wherein the modifying agent is 3-mercaptopropionic acid.

24. The method as claimed in claim 22, wherein the modifying agent is 2-aminoethanethiol.
